(19) United States
(12) Patent Application Publication
(10) Pub. No.: US 2007/0134003 A1
(43) Pub. Date: Jun. 14, 2007

(54) Optical transceiver case

(76) Inventors: Jyung Chan Lee, Daejeon-city (KR); Jun Ki Lee, Daejeon-city (KR); Hyun Jae Lee, Daejeon-city (KR); Kwang Joon Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/405,765

(22) Filed: Apr. 18, 2006

(30) Foreign Application Priority Data
Dec. 12, 2005 (KR) 10-2005-0121978

(51) Int. Cl. H04B 10/00

(52) U.S. Cl. 398/164

(57) ABSTRACT

An optical transceiver case is provided. The optical transceiver case has an optical transmission/reception device and a PCB that operates the optical transmission/reception device. The optical transceiver case includes a lower plate and an upper plate. The lower plate supports the optical transmission/reception device and the printed circuit board, and includes handle grooves formed on both external sides of the lower plate to allow the optical transceiver case to be mounted/detached to/from an optical transmission/reception system's board. The upper plate is coupled to the lower plate to mount the optical transmission/reception device and the printed circuit board, and includes a protuberance embossed on an external upper surface of the upper plate in order to discharge heat generated from the optical transmission/reception device and the PCB to the outside. The optical transceiver case is easily mounted detached to/from on optical transmission/reception system's board and maintains a constant internal temperature.

### CROSS-REFERENCE TO RELATED PATENT APPLICATION

This application claims the benefit of Korean Patent Application No. 10-2005-0121978, filed on Dec. 12, 2005, in the Korean Intellectual Property Office, the disclosure of which is incorporated herein in its entirety by reference.

### BACKGROUND OF THE INVENTION

1. Field of the Invention

The present invention relates to an optical transceiver case, and more particularly, to an optical transceiver case that is easily mounted/detached to/from an optical transmission/reception system's board and that maintains a constant internal temperature.

2. Description of the Related Art

An optical transmission/reception system uses a module having an optical transmission/reception function of transmitting an optical signal through an optical fiber and detecting an optical signal transmitted through the optical fiber. The module (referred to as an optical transceiver hereinafter) performing the optical transmission/reception function includes an optical transmission/reception device having an optical transmitter creating/transmitting an optical signal and an optical receiver detecting an optical signal, and a printed circuit board (PCB) operating the optical transmission/reception device and serving as an external electrical interface.

The optical transceiver requires an appropriate temperature so as to operate properly. Also, it is required that an optical transmission/reception system easily adapts to an environment in an aspect of a system. Here, the environment means a factor that generates a neighbourhood temperature change. Therefore, the optical transceiver in use should have operation characteristics that may operate in a wider range of temperature environments. Also, it is required that the optical receiver is easily assembled and has a structure easily dealt with in an aspect of manufacturing.

A prior art has used a variety of methods in order to reduce a temperature change. These methods include a method of closely attaching optical transmission/reception devices and a printed circuit board (PCB) that constitute an optical transceiver to a heat transfer metal body in order to transfer heat generated from the optical transmission/reception devices and the PCB to a case; a method of separately providing a cage having a plurality of lines of thin heat-sink fins formed on an exterior of a case in order to swiftly perform a heat sink operation; and a method of appropriately combining thermal conductive pads and heat blocking pads in order to transfer and block heat from optical transmission/reception devices and the PCB. However, the above-descried prior art methods have focused on transferring heat from the case of the optical transceiver to the outside in order to reduce the temperature change of the case, but have almost not blocked heat coming into the inside of the optical transceiver when the temperature of the outside is relatively high.

Also, an optical transceiver case applied to a prior art optical transceiver conforming to a 300pin multi-source agreement (MSA) standard has a wide area more or less and a lower height, which reduces a mounting or detachment efficiency in an aspect of user convenience.

### SUMMARY OF THE INVENTION

The present invention provides an optical transceiver case including a protuberance formed to maintain a temperature between the inside and the outside of the optical transceiver case constant, a handle groove formed to allow the optical transceiver case to be easily mounted/detached to/from an optical transmission/reception system board, a seat groove formed to accommodate thermal expansion or contraction of a printed circuit board of the optical transceiver, and a function extension groove formed to accommodate function extension.

According to an aspect of the present invention, there is provided an optical transceiver case allowing an optical transmission/reception device and a printed circuit board that operates the optical transmission/reception device, to be mounted in an inside of the optical transceiver case, the optical transceiver case including: a lower plate supporting the optical transmission/reception device and the printed circuit board, and having handle grooves formed on both external sides of the lower plate to allow the optical transceiver case to be mounted/detached to/from an optical transmission/reception system's board by a user; and an upper plate coupled to the lower plate to mount the optical transmission/reception device and the printed circuit board, and having a protuberance embossed on an external upper surface of the upper plate in order to discharge heat generated from the optical transmission/reception device and the printed circuit board to the outside and to block heat generated from the outside, thereby maintaining an internal temperature of the optical transceiver case constant.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an optical transceiver case according to an embodiment of the present invention as viewed from an upper side;

FIG. 2 is a perspective view of the optical transceiver case of FIG. 1 as viewed from a lower side;

FIG. 3 is a view showing an inner structure of an upper plate 101 of the optical transceiver case of FIG. 1; and

FIG. 4 is a view showing an inner structure of a lower plate 102 of the optical transceiver case of FIG. 1.

### DETAILED DESCRIPTION OF THE INVENTION

The present invention will now be described more fully with reference to the accompanying drawings, in which exemplary embodiments of the invention are shown.

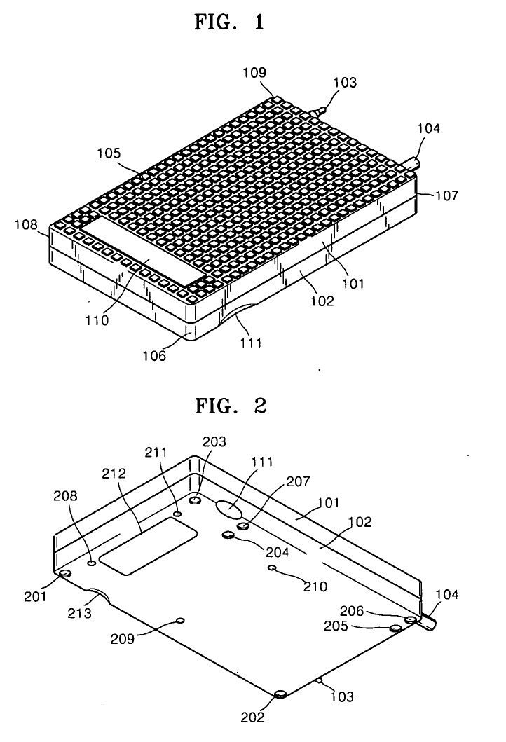

FIG. 1 is a perspective view of an optical transceiver case according to an embodiment of the present invention as viewed from an upper side. The optical transceiver case 100 is an optical transceiver case used to an optical transceiver conforming to a 300pin Multi-Source Agreement (MSA) standard.

Referring to FIG. 1, the optical transceiver case 100 has a structure separated into an upper plate 101 and a lower plate 102. Each of the corners 106 through 109 of the optical transceiver case 100 is rounded to remove its angled feature.

An optical transmission/reception device and a printed circuit board (PCB) allowing an optical transmission/reception device to operate are mounted in the inside of the optical transceiver case 100. The upper plate 101 and the lower plate 102 are fixedly coupled to each other. The optical transmission/reception device and the PCB are mounted through the coupling of the upper and lower plates 101 and 102.

An information print plate 110 is formed on a predetermined position of the upper plate 101 to display a variety of information of the optical transceiver (e.g., a manufacturer logo, an optical transceiver's name, and a serial number).

The lower plate 102 supports the optical transmission/reception device and the PCB, and includes handle grooves 111 formed on both external sides to allow the optical transceiver case 100 to be mounted/detached to/from the optical transmission/reception system's board by a user. Referring to FIG. 1, the optical transceiver case 100 used to an optical transceiver conforming to a 300pin MSA standard has a wide area more or less and a low height. The optical transceiver case 100 having the above shape reduces a mounting or detachment efficiency in an aspect of user convenience. To solve these problems, handle grooves 111 are formed on both external sides of the lower plate.

Quadrangular protuberances 105 are embossed on an external upper surface of the upper plate 101. The interval between the protuberances 105 is ⅓ shorter than a horizontal or vertical length of the protuberance. Also, the height of the protuberance is ¼ shorter than a horizontal or vertical length of the protuberance. Such a structure discharges internal high heat of the optical transceiver case 100 to the outside and minimizes heat transfer to the inside of the optical transceiver case 100 when outside temperature is higher than the temperature of the inside of the optical transceiver case 100.

The internal temperature change of the optical transceiver case 100 is made less sensitive to outside temperature by forming the protuberances 105, which minimizes a remarkable temperature change of a PCB mounted within the optical transceiver case 100, so that the optical transceiver may maintain optimized operation characteristics.

An unexplained reference numeral 103 represents an optical receiver output port among optical transmission/reception devices constituting the optical transceiver, and a reference numeral 104 represents an optical modulator output port among the optical transmission/reception devices constituting the optical transceiver.

FIG. 2 is a perspective view of the optical transceiver case of FIG. 1 as viewed from a lower side. Referring to FIG. 2, the lower plate 102 of the optical transceiver case 100 includes screw fixing holes 201 through 203 for connection to the upper plate 101, screw fixing holes 204 through 207 fixing the optical modulator of the optical transmission/reception devices contained in the optical transceiver case 100, and screw fixing holes 208 through 211 fixing a PCB mounted within the optical transceiver case 100 according to a 300pin MSA standard.

Each of the screw fixing holes 201 through 203 for connection to the upper plate 101 and the screw fixing holes 204 through 207 fixing the optical modulator has a structure preventing a head portion of a screw from protruding to the outside of the lower plate 102. With such a structure, a screw's head may not protrude to the outside.

Handle grooves 111 and 213 are formed in predetermined positions located on both external sides of the lower plate 102 to allow the optical transceiver case 100 to be easily mounted/detached to/from an optical transmission/reception system's board.

A reference numeral 212 represents an electric interface location portion of the optical transceiver conforming to a 300pin MSA standard. The handle grooves 111 and 213 are formed in predetermined positions of the lower plate 102, i.e., both sides of the electric interface location portion 212 of the lower plate 102 of the 300pin optical transceiver to allow the optical transceiver case 100 to be easily mounted/detached to/from the optical transmission/reception system's board.

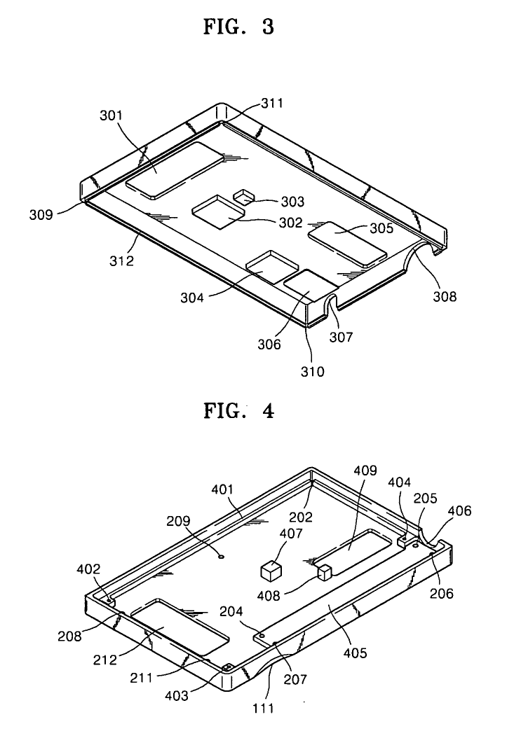

FIG. 3 is a view showing an inner structure of an upper plate 101 of the optical transceiver case of FIG. 1. Referring to FIG. 3, a first groove 301 formed in the inside of the upper plate 101 is designed to extend the PCB's function of the optical transceiver. The first groove 301 is formed in the inner surface of the lower end of the information print plate 110 of the upper plate 101 (of FIG. 1).

Each of the protuberances 302 through 304 embossed on the inside of the upper plate 101 is formed to contact electronic devices of element parts mounted on the PCB of the optical transceiver. Each of the protuberances 302 through 304 serves as a heat transfer connection element transferring heat generated from the electronic devices.

A second groove 305 is formed in a portion where a light source generation laser of the optical transmission/reception devices constituting the optical transceiver is located. The second groove 305 serves as a heat transfer connection element transferring heat generated from the light source generation laser.

A third groove 306 is formed in a portion where an optical receiver of the optical transmission/reception devices constituting the optical transceiver is located. The third groove 306 serves as a heat transfer connection element transferring heat generated from the light source generation laser.

An optical receiver output port fixing hole 307 formed in one lateral side of the upper plate 101 is formed to fix the optical receiver output port 103 of the optical transceiver, and an optical modulator output port fixing hole 308 is formed to fix the optical modulator output port 104 of the optical transceiver.

Each of screw fixing holes 309 through 311 formed in the upper plate 101 allows a screw to rise from each of the screw fixing holes 201 through 203 formed in the lower plate 102 and to be fixed in the upper plate 101.

A seat groove 312 is formed along an inner peripheral surface in order to allow the PCB of the optical transceiver to be seated and fixedly mounted. The seat groove 312 formed in the upper plate 101 fixes the PCB of the optical transceiver in cooperation with a seat groove 401 formed in the lower plate 102, which will be described below.

The present invention provides the seat grooves 312 and 401 to the upper plate 101 and the lower plate 102, respectively, to fix the PCB of the optical transceiver, thereby solving problems caused by thermal expansion and contraction of the PCB and allowing the optical transceiver to operate more stably.

FIG. 4 is a view showing an inner structure of a lower plate 102 of the optical transceiver case of FIG. 1. Referring to FIG. 4, the seat groove 401 is formed along an inner peripheral surface in order to allow the PCB of the optical transceiver to be seated and fixedly mounted. Here, the seat groove 401 formed in the lower plate 102 fixes the PCB of the optical transceiver in cooperation with the seat groove 312 (of FIG. 3).

Each of screw fixing holes 309 through 311 formed in the upper plate 101 allows a screw to rise from each of the screw fixing holes 201 through 203 formed in the lower plate 102 and to be fixed in the upper plate 101.

Screw fixing holes 402 through 404 formed in the lower plate 102 allow the PCB of the optical transceiver to be seated and fixedly mounted.

An optical modulator location portion 405 protrudes to allow an optical modulator of the optical transmission/reception devices constituting the optical transceiver to be positioned on the optical modulator location portion 405.

An optical modulator output port fixing hole 406 formed one lateral side of the lower plate 102 is coupled to the optical modulator output port fixing hole 308 (of FIG. 3) through a screw to fix the optical modulator output port of the optical transmission/reception devices constituting the optical transceiver.

Each of protuberances 407 and 408 embossed on the inside of the lower plate 102 is formed to contact electronic devices of element parts mounted on the PCB of the optical transceiver. Each of the protuberances 407 and 408 serves as a heat transfer connection element transferring heat generated from the electronic devices.

A reference numeral 409 represents a groove in consideration of the size of the light source generation laser of the optical transmission/reception devices constituting the optical transceiver.

The optical transceiver case according to the present invention may be easily mounted/detached to/from the optical transmission/reception system's board using the handle grooves formed in both sides of the lower plate.

According to the present invention, it is possible to provide the optical transceiver case having a simplified structure in consideration of an assembly process, receiving heat generated from the inside of the optical transceiver case and discharging the received heat to the outside, and minimizing transferring of external heat to the inside of the optical transceiver case.

Also, according to the present invention, a function extension groove is formed in a predetermine position of the upper plate to extend the optical transceiver's function, and the seat grooves are formed along the inner peripheral surfaces of the upper plate and the lower plate, respectively, to fix the PCB. With such a structure, the problems caused by the thermal expansion and contraction of the PCB are solved, so that the optical transceiver may operate more stably.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical transceiver case allowing an optical transmission/reception device and a PCB (printed circuit board) that operates the optical transmission/reception device, to be mounted in an inside of the optical transceiver case, the optical transceiver case comprising:
a lower plate supporting the optical transmission/reception device and the printed circuit board, and having handle grooves formed on both external sides of the lower plate to allow the optical transceiver case to be mounted/detached to/from an optical transmission/reception system's board; and
an upper plate coupled to the lower plate to mount the optical transmission/reception device and the printed circuit board, and having a protuberance embossed on an external upper surface of the upper plate in order to discharge heat generated from the optical transmission/reception device and the PCB to the outside and to block heat generated from the outside, thereby maintaining an internal temperature of the optical transceiver case constant.

2. The optical transceiver case of claim 1, wherein the protuberance comprises a plurality of protuberances embossed in a quadrangular prism shape on an external upper surface of the upper plate.

3. The optical transceiver case of claim 2, wherein the interval between the protuberances is ⅓ of the protuberance's length.

4. The optical transceiver case of claim 3, wherein each of heights of the protuberances is ¼ of the protuberance's length.

5. The optical transceiver case of claim 2, wherein each of heights of the protuberances is ¼ of the protuberance's length.

6. The optical transceiver case of claim 1, wherein the optical transceiver case is applied to an optical transceiver conforming to a 300pin MSA (multi-source agreement) standard.

7. The optical transceiver case of claim 6, wherein the handle grooves are formed on both external sides that correspond to a 300pin electric interface of the lower plate.

8. The optical transceiver case of claim 6, wherein a function extension groove is formed in a predetermined inner position of the upper plate to extend a function of the PCB.

9. The optical transceiver case of claim 8, wherein the function extension groove is formed in a vertical position that corresponds to a 300pin electric interface of the lower plate.

10. The optical transceiver case of claim 1, wherein a seat groove is formed in an inner peripheral surface of each of the upper plate and the lower plate in order to fixedly mount the PCB of the optical transceiver.

11. The optical transceiver case of claim 1, wherein a function extension groove is formed in a predetermined inner position of the upper plate to extend a function of the PCB.
